(19) United States
(12) Patent Application Publication
(10) Pub. No.: US 2007/0125382 A1
(43) Pub. Date: Jun. 7, 2007

(54) Bordier mask

(76) Inventor: Francisco Bordier Leal, El Paso, TX (US)

Correspondence Address: FRANCISCO BORDIER LEAL, #317 OLIVIA CIR, EL PASO, TX, 79912, US

(21) Appl. No.: 11/099,290

(22) Filed: Dec. 6, 2005

(51) Int. Cl. A62B 23/02; A62B 18/08

(52) U.S. Cl. 128/205.27; 128/207.12; 128/206.17

(57) ABSTRACT

BORDIER MASK is designed with the purpose to help prevent bronchial sickness and others. This mask is composed of two valves. One is the inhale valve and the other is the exhale valve. It also has a hose that connects the mask to the filter holder from the admission valve. The other extreme to the filter holder is installed between the clothing and the body to the chest height to breathe the warm air that is needed to prevent cold sickness. The filter holder may carry filter with or without medical chemicals.

### FIELD OF THE INVENTION

The purpose of this invention is to help prevent sickness to the respiratory system like the flu, common cold, bronchitis, and other virus or bacteria, biological chemicals, etc. that exist in the environment that is caused purposely or by natural contamination. This mask is designed to breathe one's own body warmth with neutral filters inside the mask or with chemicals that neutralizes those illnesses.

### BACKGROUND OF THE INVENTION

It is well known that as you breathe heated air and someone exits to cold exterior temperature, it can cause bronchial or respiratory sickness due to the rough change in the air temperature that you breathe. The BORDIER MASK is designed to continue breathing warm air from the warm body once you may start breathing cold climate air. The mask helps avoid respiratory sickness and it also helps prevent contagious viruses from people who carry it. Additional filters with chemical substances may be added to this mask to help neutralize the effects from the different germs, viruses, bacteria, etc. as it requires.

### OBJECTS OF THE INVENTION

The objective of this invention is to prevent respiratory sicknesses that are more common in cold climates. The BORDIER MASK also helps accomplish breathing tasks in sports, playing activities, etc with comfort and fewer probabilities of sickness. It also has the option to apply or remove medical chemicals in the filter holder that helps open the respiratory breathing ducts and in some cases help cure them.

### SUMMARY OF THE INVENTION

This invention includes a light weighted and resistant semi-mask that is applied on the face in a perfect seal. To avoid the entry of air between the skin and the mask, the purpose of this invention is to breathe warm air that comes from the space between the clothing and the body up to the chest height. This is the reason why the risk of acquiring respiratory sickness is minimized. Breathing in a warm climate environment and changing roughly to a cold climate environment is proven to acquire respiratory sickness. The BORDIER MASK is designed to help prevent sickness that may be provoked by humans, viruses, bacteria, biological chemicals, etc. This mask has two breathing valves. One valve is for inhaling and the other is for exhaling breathing air. The inhaling air valve is connected to a hose that leads to a filter with or without the required neutralized chemicals. The exhale air expulsion valve is to allow the breathing air to exit. The filter holder has the shape of a reversed “U”. This design provides comfort so that the hose does not obstruct or disturb. It also helps to hold the filter holder on the neck of the shirt, jacket, etc. A tie rod towards the neck holds the filter holder. The filter that is regularly used for going out, working, sports, etc. is from a fibrous material that does not disturb the air passage that is required for breathing. A portion of this filter, as well as the chemical containing filters enter through the gap of the filter holder that is designed for this purpose. This filter holder is covered with a replaceable bag made of a soft material that does not hurt the skin when contact is made and it allows the circulation of air. This bag has an elastic opening in the superior part to adapt to the filter holder and a close in the inferior part to facilitate the change of filters, removal of filter, and to wash or replace the filter. It is easily removable on the side where the hose is connected as previously disconnected. They are as wide enough to cover the ears and are lined with a soft fabric as in the interior of the mask. To help protect from the cold air, it also has a tie rod at the height of the ears that passes on top of the head to adjust and apply it on the desired location. The BORDIER MASK also has an excellent protector for use in desert storms to alleviate the aggressiveness of the sand storms. The BORDIER MASK has removable eye protective lenses that can be used and removed with clasps, Velcro material, etc. as shown in FIG. 10, item number (1). In hot climate, it helps breathe cooler and more humid air than the existing atmosphere air. The BORDIER MASK can also be used in hospitals, manufacturing plants and in places where dangerous and harmful dusts or other contaminants exist.

### BRIEF DESCRIPTION OF THE DRAWINGS

FIG. 1 demonstrates all the components of the BORDIER MASK and how it is designed.

FIG. 2 demonstrates the mask with the inhale suction valve, exhale expulsion valve, and the wide tie rod with clasp that sufficiently covers the ears and the head.

FIG. 3 demonstrates the hose that connects the mask with the filter holder.

FIG. 4 demonstrates the filter holder from its side view design

FIG. 5 demonstrates posterior view of the filter holder and how the anterior part is larger than the posterior part; it also demonstrates how the filter is placed.

FIG. 6 demonstrates front view of the bag that covers the filter holder. It has an opening in the upper part and a zipper in the lower part of the bag

FIG. 7 demonstrates the filter with its fibrous material.

FIG. 8 demonstrates front view of the filter holder placed inside the bag.

FIG. 9 demonstrates the mask with the protective lenses applied on the head.

FIG. 10 demonstrates the protective lenses by its interior side to demonstrate the Velcro material item 1.

### DETAILED DESCRIPTION OF THE PREFERRED EMBODIMENT

The drawings illustrate how the BORDIER MASK is designed. The way to use the mask is similar to any facemask as commonly known as those that fasten and adjust to fit for size. It also includes the tie rod that passes over the head. Its use is to sustain the mask in the desired place.

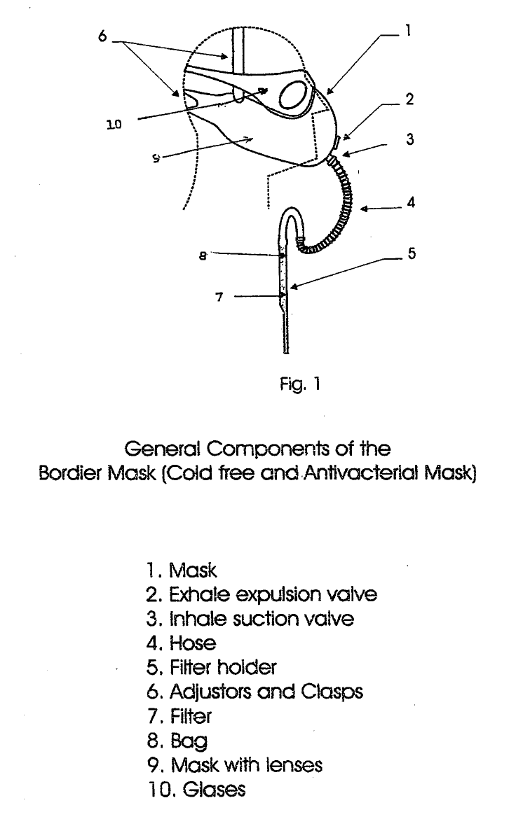

FIG. 1 demonstrates the general idea how the mask is installed. Item (1) demonstrates the body of the mask. Item (2) demonstrates the exhale expulsion valve. Item (3) demonstrates the inhale suction valve where the hose is connected that is connected to the filter holder. Item (4) demonstrates the hose. Item (5) demonstrates the filter holder. Item (6) demonstrates the tie rods and the clasps.

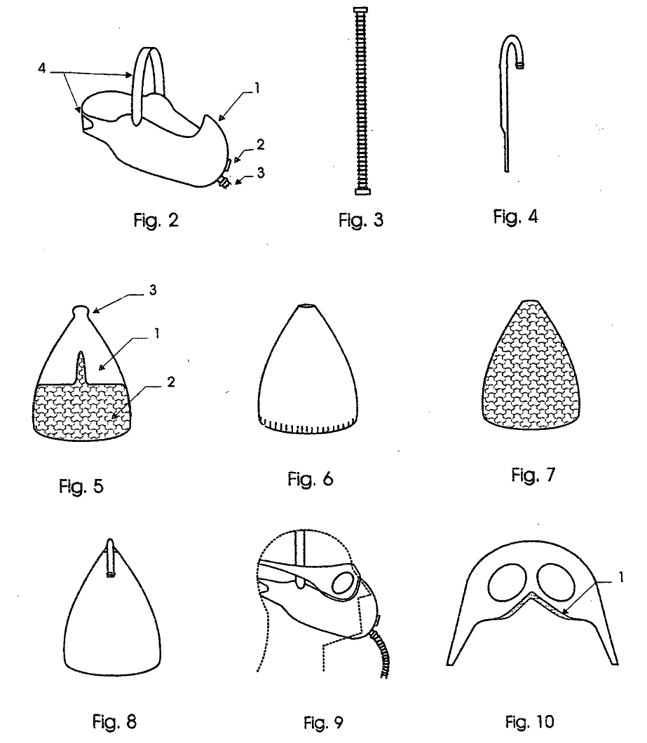

FIG. 2 demonstrates the mask with the wide holder to cover the ears. The wide holder and the interior part of the mask are lined with soft material that is appropriate to protect from the cold. The wide holder can be adjusted to be even wider behind the ears to fasten the tie rod from its opposite side and to the desired measure. Item (3) demonstrates the inhale valve. Item (2) demonstrates the exhale valve. Item (1) demonstrates the body of the mask. Item (4) demonstrates the tie rod that passes over the head and the adjustable clasps.

FIG. 3 demonstrates the hose that connects the mask with the filter holder FIG. 1 item (5) by the inhale valve FIG. 2 item (3).

FIG. 4 as seen from its side view in the form of an upside down “U”. The upper extreme of the filter holder is round to connect the hose. The other extreme is adapted between the clothing and the body. It is wide and thin with a double wall, similar to a flattened hose. It is used to insert the filter that is used to circulate the air. As it is shown in FIG. 1 item (7).

FIG. 5 item (1) demonstrates the posterior view of the filter holder where the filter is inserted with or without medication against virus, bacteria, etc. Item (2) demonstrates that a portion of the filter is inserted in the filter holder. Item (3) demonstrates the protuberance that does not allow the bag move from its place.

FIG. 6 demonstrates the bag cover where the filter holder is inserted. With its measure and form of the filter holder, the form of this design is special to facilitate its handling. The bag has an elastic opening in the superior part where the filter holder is inserted, sealing perfectly. It also has a zipper in the lower part to facilitate the removal of the filter and the bag every time it is necessary for washing and replacing. It also demonstrates the standard measure of the bag.

FIG. 7 demonstrates the filter.

FIG. 8 demonstrates the front view of the filter holder inside the bag.

FIG. 9 demonstrates the mask with the lenses applied on the head.

FIG. 10 demonstrates the lenses from its interior view. Item number (1) demonstrates the Velcro to be attached or unattached to the mask.

I claim the following five items:

1. The purpose of the mask is to allow you to breathe warm air from body heat.

2. Additional medical chemicals may be added to the filter inside the filter holder.

3. The mask protects the ears from the cold weather and the eyes from sandstorms and harmful dust chemicals.

4. The invention of the filter holder.

5. Protective lenses protect eyes from sand storms and harmful dust chemicals.
